(19) United States
(12) Patent Application Publication
(10) Pub. No.: US 2023/0294971 A1
(43) Pub. Date: Sep. 21, 2023

(54) AN EXTRACTION UNIT FOR EXTRACTING A ROBOT

(71) Applicant: Maytronics Ltd., Kibutz Yizrael (IL)

(72) Inventors: Hezi Konedro, Kibutz Yizrael (IL); Malka Klein Frucht, Kibutz Yizrael (IL); Yuval LIBERMAN, Kibutz Yizrael (IL)

(73) Assignee: Maytronics Ltd., Kibutz Yizrael (IL)

(21) Appl. No.: 18/318,680

(22) Filed: May 16, 2023

Related U.S. Application Data
(60) Provisional application No. 63/383,696, filed on Nov. 14, 2022.

(30) Foreign Application Priority Data
Mar. 16, 2022 (IL) 291426

(51) Int. Cl. B66F 19/00

(52) U.S. Cl. CPC B66F 19/00; E04H 4/1654

(57) ABSTRACT

An extraction unit that may includes a handle, a bendable intermediate element; and an extraction unit interfacing element that is configured to interface with a robot; wherein the bendable intermediate element is connected between the handle and the extraction unit interfacing element.

### CROSS REFERENCE

This application claims priority from IL patent application 291426 filing date Mar. 16, 2022 and from U.S. provisional patent application 63/383,696 filing date Nov. 14, 2022—both are being incorporated herein by reference.

### BACKGROUND OF THE INVENTION

Robots that are cordless may perform various operations within a pool and from time to time should be extracted from the pool.

For example—a robot that is cordless may be battery powered. When the battery is empty the robot should be extracted from the pool (even from the bottom of the pool)—without the assistance of a cable that is connected to the robot.

Manual extraction of a robot (while at least partially submerged) may require a human to guide an end of the extraction unit through a path till reaching a robot interface that is formed in an exterior of the robot, while the robot interface is still submerged—and while the image of the path itself is distorted due to the refraction of light rays as they travel from the fluid of the pool into the air.

The problem is even more acute when the robot interface is at least partially hidden from the human.

There is a growing need to provide an extraction unit that can ease the extraction of a robot.

### SUMMARY

There may be provided an extraction unit that may include a handle, a bendable intermediate element, and an extraction unit interfacing element that is configured to interface with the robot. The bendable intermediate element is connected between the handle and the extraction unit interfacing element.

There may be provided method for extracting a robot that is at least partially submerged, the method may include extracting the robot by an extraction unit. The extraction unit may include a handle, a bendable intermediate element, and an extraction unit interfacing element that is configured to interface with the robot. The bendable intermediate element is connected between the handle and the extraction unit interfacing element.

There may be provide an extraction unit, that includes a handle; and an extraction unit interfacing element that is configured to interface with a robot. An exterior of a cross section of the extraction unit interfacing element comprises an internal spline and an external spline that differ from each other, wherein the internal spline and the external spline define an asymmetrical hook. The cross section is taken along a virtual plane that passes through the length of the extraction unit.

There may be provided a method for extracting a robot that is at least partially submerged, the method may include: extracting the robot by an extraction unit that comprises a handle; and an extraction unit interfacing element that is configured to interface with a robot; wherein an exterior of a cross section of the extraction unit interfacing element exterior comprises an internal spline and an external spline that differ from each other, wherein the internal spline and the external spline define an asymmetrical hook.

### BRIEF DESCRIPTION OF THE DRAWINGS

In order to understand the invention and to see how it may be conducted in practice, preferred embodiments will now be described, by way of non-limiting examples only, with reference to the accompanying drawings.

FIG. 1 is an example of an extraction unit;

FIG. 2 illustrates examples of extraction units;

FIG. 3 is an example of an extraction unit and a robot;

FIG. 4 is an example of an extraction unit and a robot;

FIGS. 5-6 illustrate examples of another extraction unit;

FIGS. 7-9 illustrates an extraction of a robot using the other extraction unit; and

FIGS. 10-11 illustrate examples of another extraction unit.

### DETAILED DESCRIPTION OF THE DRAWINGS

The term pool means any vessel that is capable of containing fluid.

Because the apparatus implementing the present invention is, for the most part, composed of mechanical components known to those skilled in the art, mechanical details will not be explained in any greater extent than that considered necessary as illustrated above, for the understanding and appreciation of the underlying concepts of the present invention and in order not to obfuscate or distract from the teachings of the present invention.

In the following specification, the invention will be described with reference to specific examples of embodiments of the invention. It will, however, be evident that various modifications and changes may be made therein without departing from the broader spirit and scope of the invention as set forth in the appended claims.

The word “may include” does not exclude the presence of other elements or steps then those listed in a claim. It is understood that the terms so used are interchangeable under appropriate circumstances such that the embodiments of the invention described herein are, for example, capable of operation in other orientations than those illustrated or otherwise described herein.

Any reference to either one of an extraction unit or a method should be applied, mutatis mutandis, to any other of the extraction unit and the method.

Any number (number of components, values of variables such as x and y, duration of measurements, and the like) provided in the application is merely a non-limited example and/or may be determined in any manner.

There may be provided an extraction unit that may include a handle, a bendable intermediate element and extraction unit interfacing element.

The bendable intermediate element is connected between the handle and the extraction unit interfacing element.

The extraction unit interfacing element is configured to interface with a robot.

The bendable intermediate element may be flexible or may not be flexible.

The bendable intermediate element may include multiple elements that are movably coupled to each other—they can move in relation to each other.

The bendable intermediate element may be configured to change, under compression, a distance between the handle and the extraction unit interfacing element.

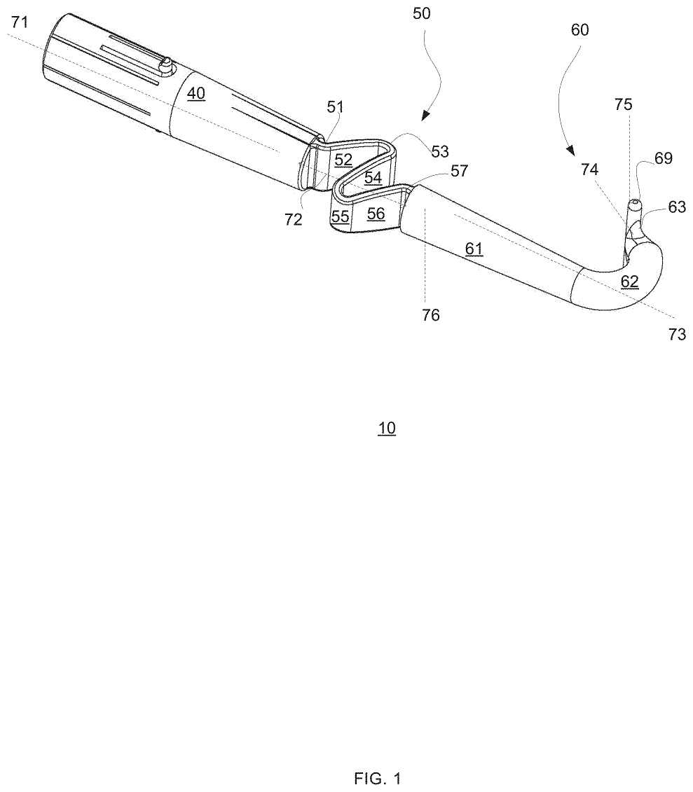

The bendable intermediate may be compresses along a compression axis (denoted 72 in FIG. 1) that is parallel to a longitudinal axis (denoted 71 in FIG. 1) of the handle.

FIG. 1 illustrates an example of extraction unit 10.

Extraction unit 10 includes handle 40 (having longitudinal axis 71), a bendable intermediate element 50 (having compression axis 72), and an extraction unit interfacing element 60.

The bendable intermediate element 50 is connected between the handle 40 and the extraction unit interfacing element 60.

The bendable intermediate element of FIG. 1 is flexible—although the bendable intermediate element may not be flexible—and may, for example, include multiple elements that are movably coupled to each other—they can move in relation to each other.

In FIG. 1, the bendable intermediate element 50 forms a S-shaped spring.

The bendable intermediate element may include linear segments and/or non-linear segments—for example may include alternating linear and non-linear segments.

In FIG. 1, the bendable intermediate element is illustrated as including top segment 51 that is curved, a first intermediate segment 52 that is linear, a second intermediate segment 53 that has a curved section, a third intermediate segment 54 that is linear, a fourth intermediate segment 55 that has a curved section, a fifth intermediate segment 56 that is linear, and a bottom segment 57 that is curved.

Each curved section may have two legs and an angle between the legs may be of any value—for example—may range between 30 degrees to 170 degrees, may range between 80 degrees and 120 degrees, and the like.

The extraction unit interfacing element may include a hook, may include one or more arched sections, one or more linear section or a combination thereof.

In FIG. 1, the extraction unit interfacing element is illustrated as including a hook that is formed from a linear top interfacing element segment 61, a curved interfacing element segment 62, and a linear end segment 63 that contacts rod 69.

The rod may be connected to another section of the extraction unit interfacing element (for example to an arched section). The rod may have a longitudinal axis that is oriented to a longitudinal axis of the arched section. The orientation may be a normal orientation of a non-normal orientation.

The linear end segment 63 has a longitudinal axis 74 that is oriented to a longitudinal axis 75 of rod 69 and is oriented to the longitudinal axis 73 of the linear top interfacing element segment 61.

The extraction unit interfacing element may include any combination of segments having any shape and having any spatial relationships between them.

The longitudinal axis 73 of the linear top interfacing element segment 61 is illustrated as being parallel to the compression axis 72 and the longitudinal axis 71 of the handle. There may be any spatial relationships between the different axes.

The rod is shaped and sized to interface with a robot interface. Especially, the rod may maintain its contact with the robot interface during the extraction of the pool.

The robot interface may be a female connector while the extraction unit interfacing element may be a male connector. The robot interface may be a male connector while the extraction unit interfacing element may be a female connector.

The robot interface may include a recess while the extraction unit interfacing element may include a protuberance.

The robot interface may include a protuberance while the extraction unit interfacing element may include a recess.

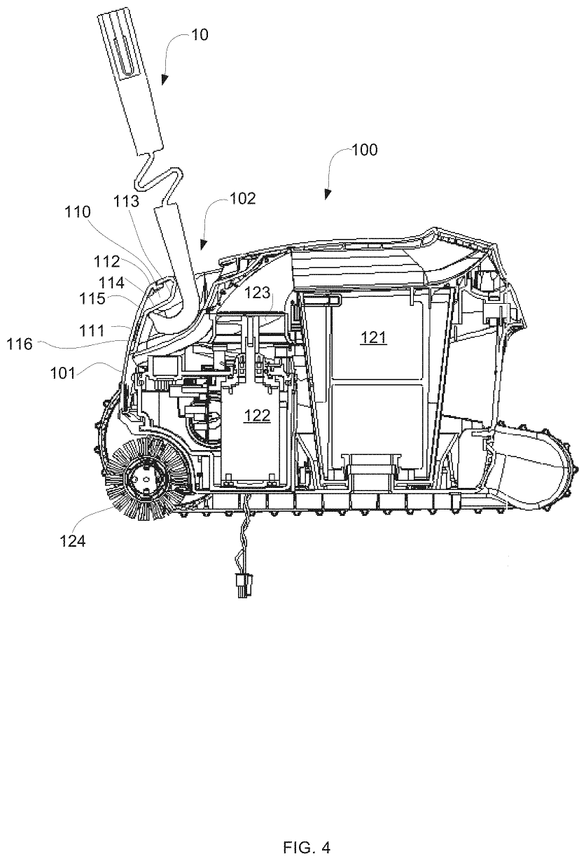

The extraction unit is elevated during the extraction process and the robot includes one or more elements (for example countering element 110 of FIG. 4) that counters the upward motion—in the sense that the robot may include the robot interface and maybe also one or more additional elements that are located above a segment of the extraction unit interfacing element.

The bendable intermediate element is configured to convert a compression along a compression axis to an angular movement of the extraction unit interfacing element—especially when the extraction unit interfacing element is pressed against or contacts a pool cleaning robot.

The angular movement may cause the extraction unit interfacing element to rotate about a rotation axis. The rotation axis may formed at a contact point between the extraction unit interfacing element and the bendable intermediate element, near the contact point (for example up to 1-5 centimeters from the contact point), and the like.

The rotation may cause the rod (or other equivalent element of the extraction unit interfacing element) to fit himself to the robot interface—when the robot interface is reached by performing a rotational movement. For example—when the robot interface is oriented to a top of an inner space through which the extraction unit interfacing element is inserted.

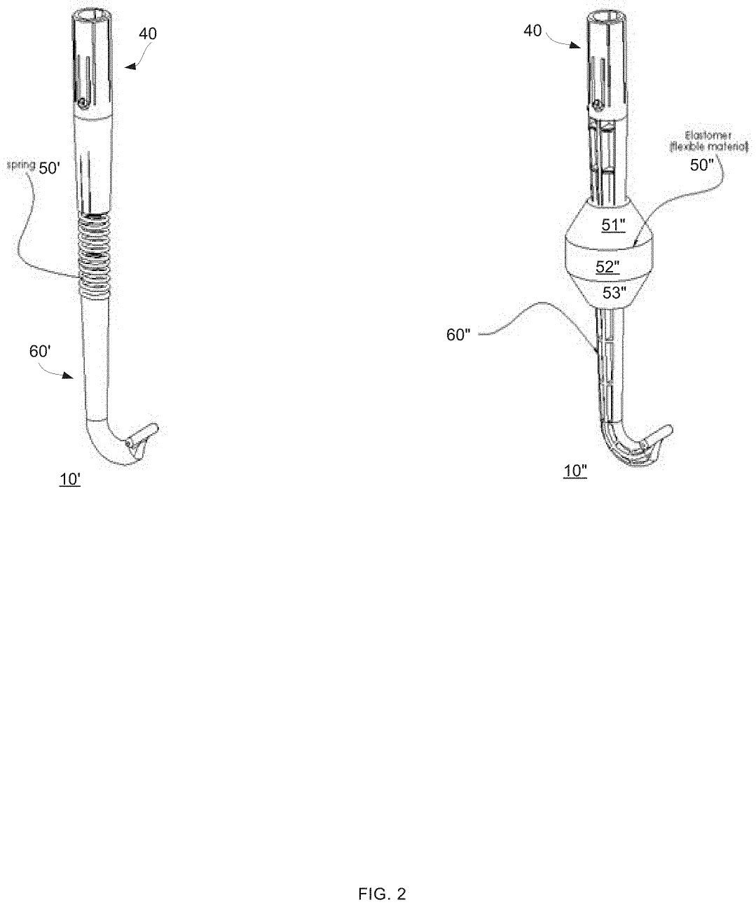

FIG. 2 illustrates two examples of extraction units 10′ and 10″ that differ from extraction unit 10 of FIG. 1 by their bendable intermediate elements.

Extraction unit 10″ includes a bendable intermediate element 50′ that is a spring that includes a spiral wire. The spiral wire has a symmetry axis that may be parallel to the longitudinal axis of the handle.

Extraction unit 10′ includes a bendable intermediate element 50″ that includes a bulk that has a top bulk part 51″, a middle bulk part 52″ and a bottom bulk part 53″ that are made of an elastic material such as an elastomer. An elastomer is a polymer with viscoelasticity (i.e., both viscosity and elasticity) and with weak intermolecular forces.

The elastomer may be a natural rubber, a styrene-butadiene block copolymer, a polyisoprene, a polybutadiene, an ethylene propylene rubber, ethylene propylene diene rubber, silicone elastomers, a fluoroelastomer, a polyurethane elastomer, a nitrile rubber, and the like.

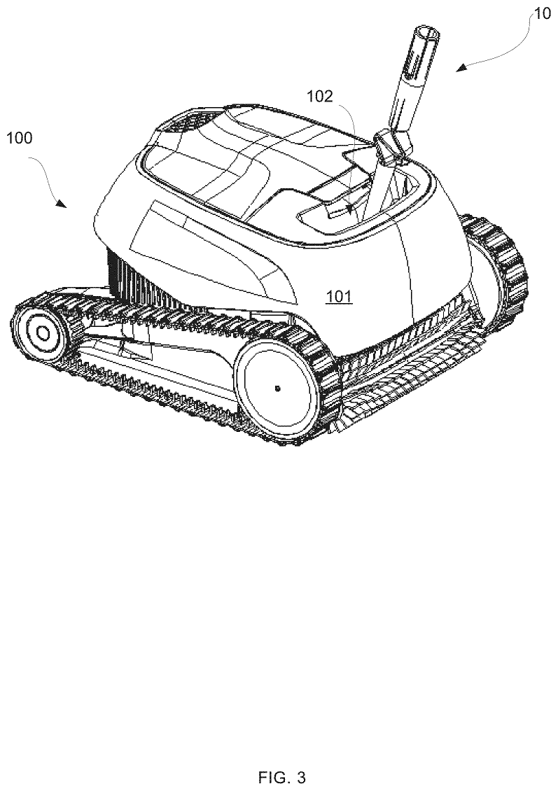

FIG. 3 illustrates an example of an extraction unit 10 that contacts a robot 100—a part of the extraction unit interfacing element is now shown because it is positioned within an inner space 102 formed by the housing 101 of the robot.

FIG. 4 illustrates a cross sectional view of a robot 100 and of the extraction unit 10 that contacts a robot interface 115. It should be noted that while FIG. 4 illustrates robot interface 115 that may be dedicated for interfacing with the extraction unit—one or more other parts of the robot (even parts that have other roles) may be used as an interface of the robot—for example a handle, a recess, and the like.

The robot 100 of FIG. 4 is a pool cleaning robot—although the extraction unit may be used to extract robots other than pool cleaning robots.

The robot 100 is illustrated as including filtering unit 121, impeller 123, pump motor 122, front brush wheel 124, housing 101, robot interface 115 and various portions of the robot that are proximate to the robot interface 115.

The inner space 102 has a curved cross section—it has a top part that is located to the right (closer to the rear part of the robot) of the robot interface 115, and has a lower part is closer to the front wall 111 of the housing 101.

The robot 100 includes a countering element 110 that includes the robot interface 115 a base segment 114, a rear segment 113, a top segment 112 and a front segment 111. The robot interface is positioned at meeting point between the base segment 114 and a front segment 116 of the inner space 102.

In order to contact the robot interface—the extraction unit interfacing element has to enter the inner space and the perform a clockwise rotation. The clockwise rotation is result of compressing the bendable intermediate element.

There may be provided a method for extracting a robot that is at least partially submerged, the method may include extracting the robot by an extraction unit. The extraction unit may include a handle, a bendable intermediate element, and an extraction unit interfacing element that is configured to interface with the robot. The bendable intermediate element is connected between the handle and the extraction unit interfacing element.

The method may include compressing the bendable intermediate element.

The method may include extracting the robot by any of the extraction units illustrated in the application.

The method may be executed by human or by a mechanical elements or mechanical device such as a robot that contacts the extraction unit.

There may be provide an extraction unit, that may include a handle; and an extraction unit interfacing element that is configured to interface with a robot. The extraction unit exterior forms an internal spline and an external spline that differ from each other, wherein the internal spline and the external spline define an asymmetrical hook.

The internal spline may be defined by five to eight control points that are associated with different radiuses.

The external spline may be defined by five to eight control points that are associated with different radiuses.

Each one of the internal spline and the external spline may be defined by a same number of control points.

The internal spline and the external spline may be defined by different numbers of control points.

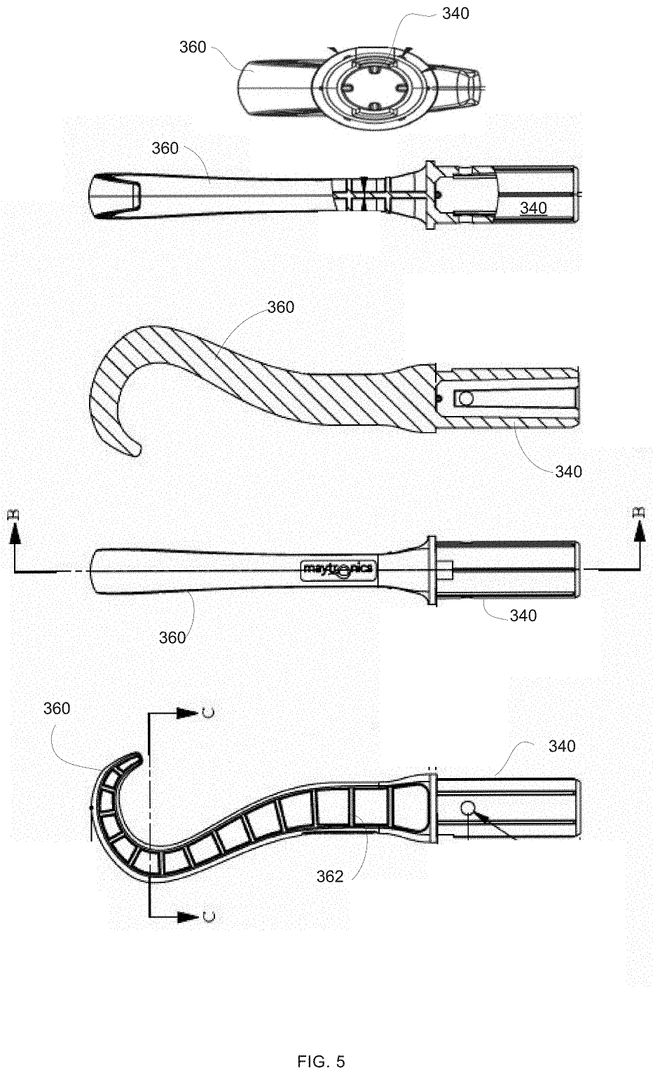

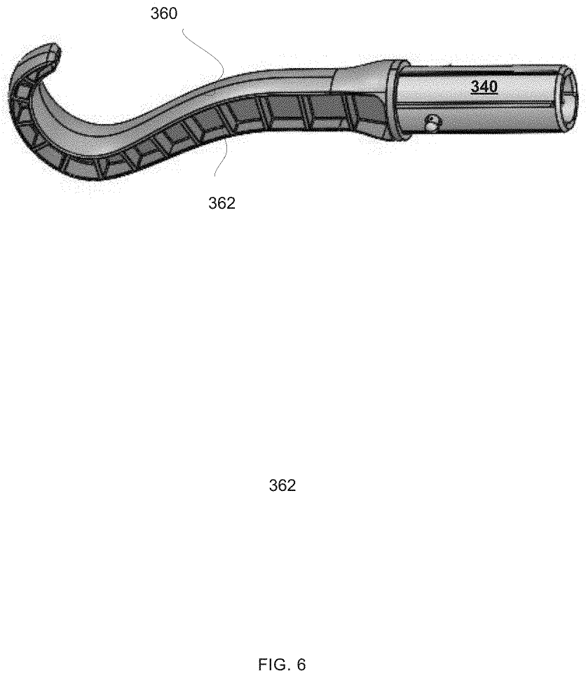

FIGS. 5-6 illustrates an example of an extraction unit 300 that includes a handle 340 and an extraction unit interfacing element 360. The extraction unit interfacing element 360 may include ribs 362 that define inner spaces and such a construction may be applied in at least a part of the extraction unit interfacing element 60 of extraction unit 10.

The extraction unit interfacing element 360 may be made of a bendable material.

There may be provide an extraction unit, that includes a handle; and an extraction unit interfacing element that is configured to interface with a robot. An exterior of a cross section of the extraction unit interfacing element comprises an internal spline and an external spline that differ from each other, wherein the internal spline and the external spline define an asymmetrical hook. The cross section is taken along a virtual plane that passes through the length of the extraction unit.

The internal spline may be defined by multiple control points—for example by five to eight control points that are associated with different radiuses.

The external spline may be defined by multiple control points—for example by five to eight control points that are associated with different radiuses.

Each one of the internal spline and the external spline may be defined by a same number of control points.

The internal spline and the external spline may be defined by different numbers of control points.

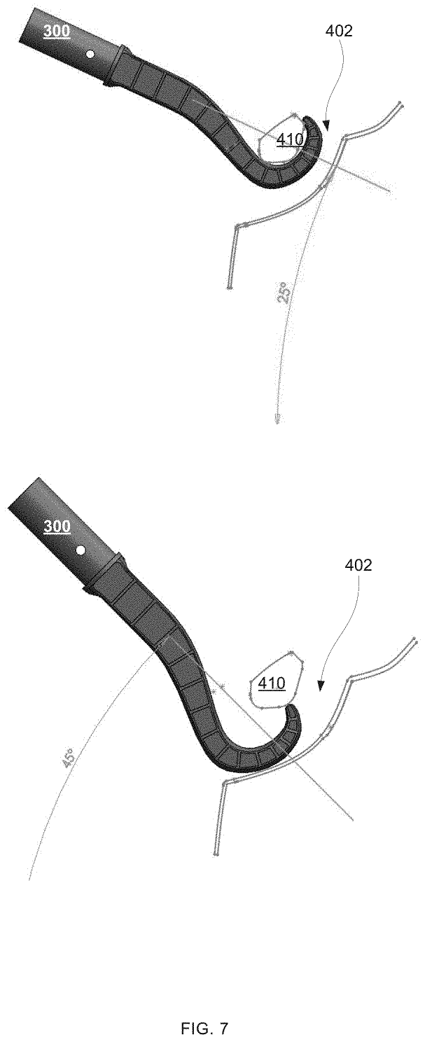

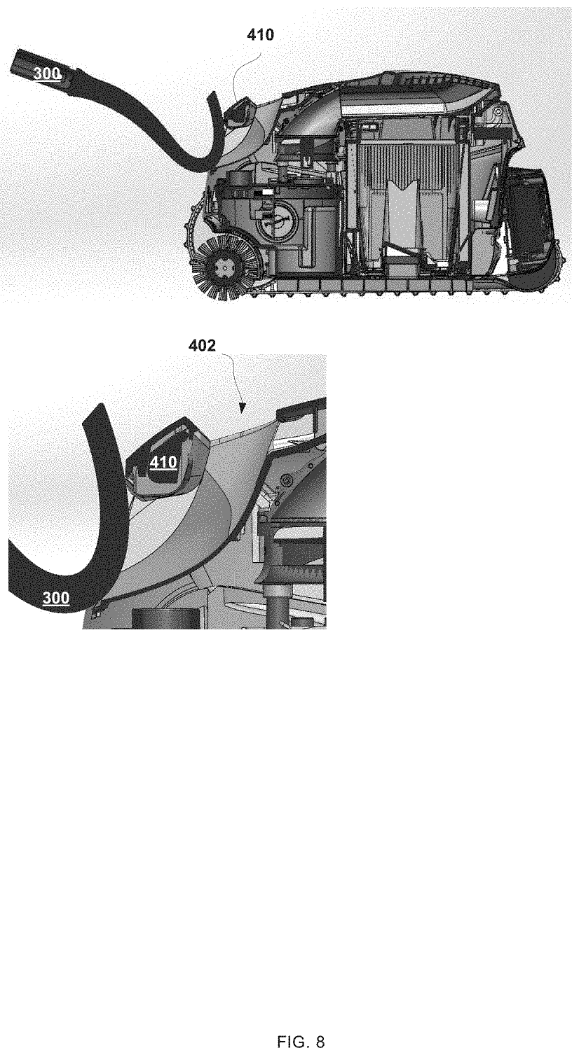

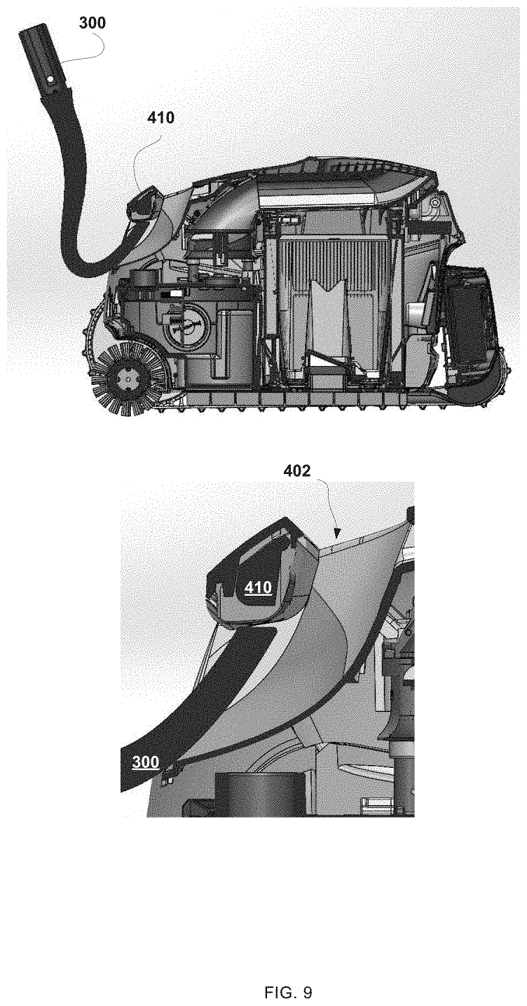

There may be provided a method for extracting a robot that is at least partially submerged, the method may include: extracting the robot by an extraction unit that comprises a handle; and an extraction unit interfacing element that is configured to interface with a robot; wherein an exterior of a cross section of the extraction unit interfacing element exterior comprises an internal spline and an external spline that differ from each other, wherein the internal spline and the external spline define an asymmetrical hook. The method may be executed by using any extraction unit of anyone of FIGS. 7-11.

FIGS. 7-9 illustrate extractions of robots (which may be a pool cleaning robot) that has a body and a countering element 410 such as a handle—that may be located above inner space 401 in which the edge of the extraction unit 300 is inserted.

The extraction unit 300 is configured to support angles of approach that may range between 20-50 degrees or between 40°-70°. When lifting the robot, the angle may be be shifted to 25°-30°—and the extraction unit will not allow the robot to disengage and fall.

The extraction unit may be tailored to a single model of robot—or may be adapted to extract multiple robots.

An extraction unit may be designed while taking into account the extraction of different pool cleaning robots from different pools and having different distances between the user and the robot, the relationship between the shape of the extraction unit and the size and the shape of the pool cleaning robot, the center of gravity of the pool cleaning robot and the match/interface between the extraction unit and the robot, the location from which the robot is extracted from the pool, the shape of the countering element and/or a pace surrounding the countering element, the part of the extraction unit that is contacted by the user, optimal and/or sub-optical contact points with the hand of the user, shapes and sizes of recesses and/or inner spaces formed by the robot.

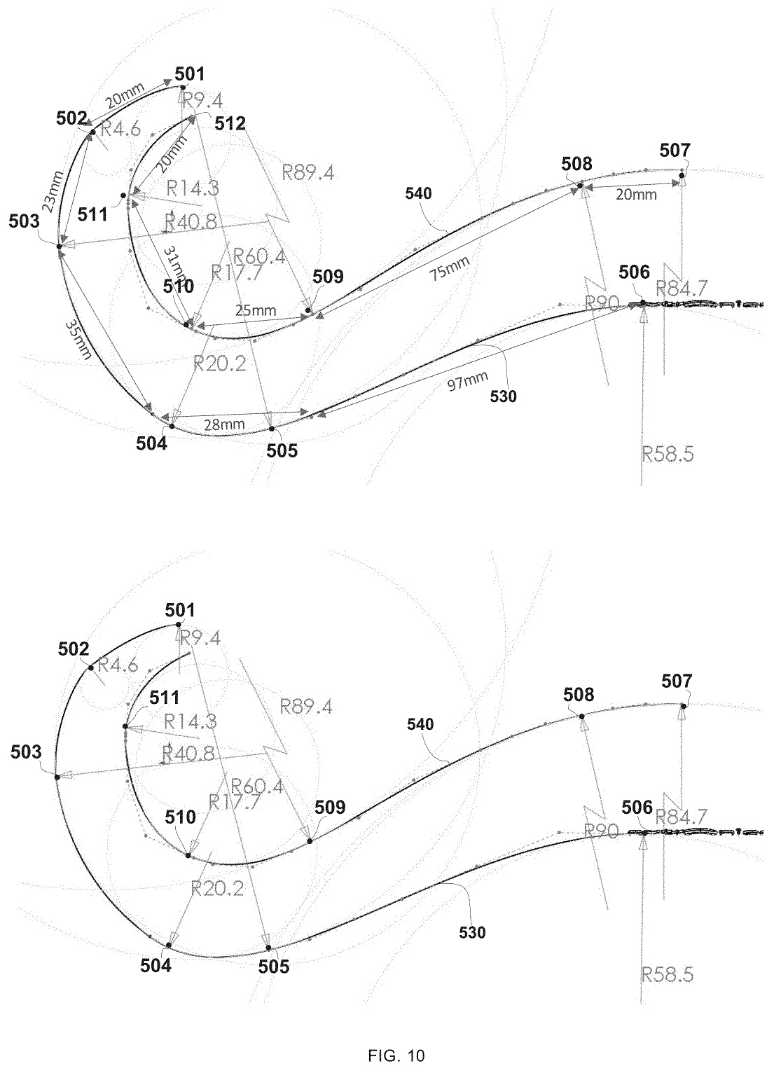

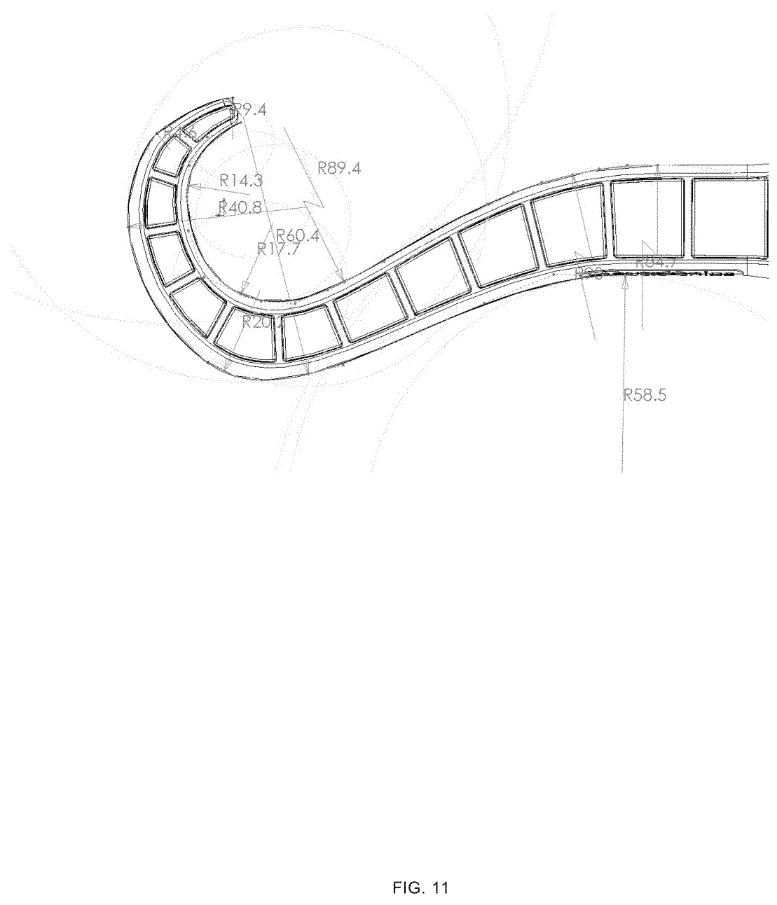

FIGS. 10-11 illustrates an example of an extraction unit. An exterior of a cross section of the extraction unit interfacing element comprises an interior spline 540 and exterior spline 530.

The interior spline may be defined control points 507, 508, 509, 510, 511 and 512—each is associated with a radius of a minimal circle that defines the curvature of the interior spline at the control point (in FIG. 10 the radiuses of control points 507, 508, 509, 510, 511 are 84.7 mm, 90 mm, 89.4 mm, 60.4 mm and 40.8 mm, respectively).

The control points 511 and 512 can be connected to each other in any manner—by a spline portion, by hale a circle, and the like.

The distance between control points 507 and 508 is 20 mm, the distance between control points 508 and 509 is 75 mm, the distance between control points 509 and 510 is 25 mm, the distance between control points 510 and 511 is 31 mm, and the distance between control points 511 and 512 is 20 mm.

The exterior spline may be defined control points 506, 505, 504, 503, 503 and 501—each is associated with a radius of a minimal circle that defines the curvature of the interior spline at the control point (in FIG. 10 the radiuses of control points 506, 505, 504, 503, 502 and 501 are 58.5 mm, 60.4 mm, 20.2 mm, 40.8 mm 4.6 mm, and 9.4 mm respectively).

The distance between control points 506 and 505 is 97 mm, the distance between control points 505 and 504 is 28 mm, the distance between control points 504 and 503 is 35 mm, the distance between control points 503 and 502 is 23 mm, and the distance between control points 502 and 511 is 20 mm.

The other extraction unit may slightly differ from the other extraction unit of FIG. 5.

“Slightly differs” may be also referred to as “about” and may include a deviation of up to 5%, 10%, 15%, 20$, 25%, 30% of one or more distance between adjacent control points and/or of one or more radius of minimal circle.

Additionally or alternatively, “Slightly differs” may be also referred to as “about” and may include a deviation of up to 1, 2, 3, 4, 5, 6, 7, 8, mm of one or more radius of minimal circle.

Additionally or alternatively, “Slightly differs” may be also referred to as “about” and may include a deviation of up to 1, 2, 3, 4, 5, 6, 7, 8, 9, 10, 11, 12, 13, 14, 15, 20 mm of one or more distances between adjacent control points.

Slightly differs “Slightly differs” may be also referred to as “about” and may include a deviation of up to 5%, 10%, 15%, 20%, 25%, 30/5 of a ratio between radiuses of minimal circuits of one or more pairs of control points.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

The phrase “may be X” indicates that condition X may be fulfilled. This phrase also suggests that condition X may not be fulfilled. For example—any reference to a robot as including a certain component should also cover the scenario in which the robot does not include the certain component. For example—any reference to a method as including a certain step should also cover the scenario in which the method does not include the certain component. Yet for another example—any reference to a robot that is configured to perform a certain operation should also cover the scenario in which the robot is not configured to perform the certain operation.

A reference to any one of the terms “including”, “comprising”, “having” may be applied mutatis mutandis to “consisting” and “consisting essentially of”.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one as or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements the mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Any combination of any component of any component and/or unit of robot that is illustrated in any of the figures and/or specification and/or the claims may be provided.

Any combination of any extraction unit illustrated in any of the figures and/or specification and/or the claims may be provided.

Any combination of any set of extraction units illustrated in any of the figures and/or specification and/or the claims may be provided.

Any combination of operations illustrated in any of the figures and/or specification and/or the claims may be provided.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe.

Thus, these terms are not necessarily intended to indicate temporal or other prioritization of such elements. The mere fact that certain measures are recited in mutually different claims does not indicate that a combination of these measures cannot be used to advantage.

We claim:

1. An extraction unit, comprising:
a handle;
a bendable intermediate element; and
extraction unit interfacing element that is configured to interface with a robot; wherein the bendable intermediate element is connected between the handle and the extraction unit interfacing element.

2. The extraction unit according to claim 1 wherein the bendable intermediate element is a flexible intermediate element.

3. The extraction unit according to claim 1 wherein the extraction unit interfacing element comprises a hook.

4. The extraction unit according to claim 1 wherein the extraction unit interfacing element comprises an arched section that is connected to a rod that has a longitudinal axis that is oriented to a longitudinal axis of the arched section.

5. The extraction unit according to claim 1 wherein the bendable intermediate element is configured to convert a compression along a compression axis to an angular movement of the extraction unit interfacing element.

6. The extraction unit according to claim 5 wherein the compression axis is parallel to a longitudinal axis of the handle.

7. The extraction unit according to claim 1 wherein the bendable intermediate element is configured to change, under compression, a distance between the handle and the extraction unit interfacing element.

8. The extraction unit according to claim 1 wherein the bendable intermediate is configured to be compresses along a compression axis that is parallel to a longitudinal axis of a segments of the handle that contacts the bendable intermediate element.

9. The extraction unit according to claim 1 wherein the bendable intermediate element comprises spring coils.

10. The extraction unit according to claim 1 wherein the bendable intermediate element comprises an S-shaped spring coil.

11. The extraction unit according to claim 1 wherein the bendable intermediate element comprises a top segment that is curved, a first intermediate segment that is linear, a second intermediate segment that has a curved section, a third intermediate segment that is linear, a fourth intermediate segment that has a curved section, a fifth intermediate segment that is linear, and a bottom segment that is curved.

12. The extraction unit according to claim 1 wherein the bendable intermediate element comprises alternating linear and non-linear segments.

13. The extraction unit according to claim 1 wherein the bendable intermediate element comprises multiple movably coupled elements that are configured to move in relation to each other once the bendable intermediate element is compressed.

14. A method for extracting a robot that is at least partially submerged, the method comprises: extracting the robot by an extraction unit that comprises a handle; a bendable intermediate element; and an extraction unit interfacing element that is configured to interface with the robot; wherein the bendable intermediate element is connected between the handle and the extraction unit interfacing element.
